(19) United States
(12) Patent Application Publication
(10) Pub. No.: US 2025/0033289 A1
(43) Pub. Date: Jan. 30, 2025

(54) SYSTEMS AND METHODS FOR CASTING CHARACTERS WITHOUT A BACKING SUBSTRATE

(71) Applicant: MATTHEWS INTERNATIONAL CORPORATION, Pittsburgh, PA (US)

(72) Inventors: Bernard A. KUHN, JR., Baden, PA (US); Paul TUNIS, Sewickley, PA (US); Jake A. VARGO, Washington, PA (US)

(21) Appl. No.: 18/787,183

(22) Filed: Jul. 29, 2024

Related U.S. Application Data
(60) Provisional application No. 63/516,332, filed on Jul. 28, 2023.

(51) Int. Cl. B29C 64/386; B29L 31/00; B33Y 50/00

(52) U.S. Cl. CPC B29C 64/386; B29L 2031/757; B33Y 50/00

(57) ABSTRACT

Methods and systems for creating a mold for a memorialization product comprising characters without a backing substrate are described herein. In a process for creating a mold, a three-dimensional (3D) model of a product design is generated. The product design includes characters with customized features. A mold design is generated based upon the 3D model of the product design. The mold design is optimized including character optimization based on the depth and bend radius of the characters. Printing instructions for creating the mold are generated and accessed by a processing device. The mold is created according to the printing instructions. A product, such as a bronze memorialization product, can be cast using the mold.

### CROSS-REFERENCE TO RELATED APPLICATIONS

This application claims priority to U.S. Provisional Application No. 63/516,332 filed Jul. 28, 2023, the entirety of which is incorporated by reference herein.

### TECHNICAL FIELD

The present disclosure is directed to creating molds and casting metal products based on said molds. More particularly, the present disclosure is directed to custom mold creation using three-dimensional printing or other similar printing techniques for creating molds for metal castings featuring characters without a backing substrate.

### BACKGROUND

Metal casting involves pouring liquid metal into a mold having an interior cavity shaped in the form of the desired product. The liquid metal is allowed to cool and solidify within the mold to produce a metal product corresponding to the shape of the interior cavity. Typical molding processes include sand casting, shell molding, permanent mold casting, investment casting, and die casting. Conventional techniques for creating molds involve labor-intensive and time-consuming manual processes. Bronze metal casting manufacturers often create one-of-a-kind products, such as signs, memorials, plaques, and sculptures. As such, conventional molds are typically unique forms that are individually created for a specific casting. Castings from such molds are often only produced once. Intricate features, such as characters or text, are specifically complex. Errors can occur in typesetting during mold creation. Furthermore, the bend radius present in many characters can cause misrun if not properly gated. Accordingly, the time and yield required to cast characters is a significant portion of the manufacturing costs associated with producing a bronze product. Metal product manufacturers would therefore benefit from processes capable of creating molds more efficiently.

### SUMMARY

Methods for creating a mold for a memorialization product comprising characters without a backing substrate are described herein. In a process for creating a mold, a three-dimensional (3D) model of a product design is generated. The product design includes characters with customized features. A mold design is generated based upon the 3D model of the product design. The mold design is optimized including character optimization based on the depth and bend radius of the characters. Printing instructions for creating the mold are generated and accessed by a processing device. The mold is created according to the printing instructions. A product, such as a bronze memorialization product, can be cast using the mold.

In some implementations, generating the 3D model includes receiving product design information, wherein the product design information contains polygonal information, converting the polygonal information to voxel information, determining an acceptable resolution for the 3D model, and generating the 3D model based on the voxel information at the acceptable resolution.

In some implementations, the product design information includes typeset information and wherein generating the 3D model further includes aligning the characters and converting the typeset information to the voxel information.

In some implementations, generating the mold design includes orienting and positioning the 3D model, determining one or more support structures for the mold design, determining one or more slicing patterns for the mold design; performing path planning for the mold design; optimizing the mold design, and generating the mold design.

In some implementations, optimizing the mold design includes at least one of: determining a wall thickness, determining a minimum mold height, determining a pour cup strategy, and determining a venting strategy.

In some implementations, creating the mold includes creating the mold using an additive manufacturing process.

In some implementations, creating the mold includes creating the mold by 3D sand printing.

In some implementations, the method further includes casting the memorialization product by adding molten metal to the created mold.

In some implementations, the character optimization includes comparing a bend radius of a character to a threshold bend radius.

In some implementations, the threshold bend radius is 60 degrees from a primary direction of initial flow for the mold.

In some implementations, in response to the bend radius of the character exceeding the threshold bend radius, augmenting the 3D model with a gate connecting the character and an adjacent character.

In some implementations, the gate includes a portion parallel to a primary direction of initial flow for the mold.

In some implementations, the method further includes customizing the gate based on the customized features of the characters.

In some implementations, the character optimization includes analyzing the depth of a character in comparison to a threshold depth.

In some implementations, in response to the depth of the character being less than the threshold depth, adding depth to the character such that the depth of the character equals the threshold depth.

### BRIEF DESCRIPTION OF THE DRAWINGS

Various aspects of at least one example are discussed below with reference to the accompanying figures, which are not intended to be drawn to scale. The figures are included to provide an illustration and a further understanding of the various aspects and examples, and are incorporated in and constitute a part of this specification, but are not intended as a definition of the limits of any particular example. The drawings, together with the remainder of the specification, serve to explain principles and operations of the described and claimed aspects and examples. In the figures, each identical or nearly identical component that is illustrated in various figures is represented by a like numeral. For purposes of clarity, not every component may be labeled in every figure.

FIG. 1 depicts an illustrative manufacturing system in accordance with one or more embodiments of the present disclosure.

FIG. 2 illustrates a sample flow diagram depicting a process for generating a product design.

FIG. 3 illustrates a sample process for creating a mold for a specific digital product model.

FIG. 4A depicts an example casting featuring a series of characters produced using traditional casting methods.

FIG. 4B depicts an example casting featuring a series of characters produced using the methods described herein.

FIG. 5 illustrates an example mold for a product comprising a bar with a series of characters attached to the bar.

FIG. 6 illustrates a simplified side view of a casted product made in a mold similar in configuration to the mold depicted in FIG. 5.

FIG. 7 illustrates various embodiments of a computing device for implementing the various methods and processes described herein.

### DETAILED DESCRIPTION

This disclosure is not limited to the particular systems, devices and methods described, as these may vary. The terminology used in the description is for the purpose of describing the particular versions or embodiments only, and is not intended to limit the scope.

As used in this document, the singular forms “a,” “an,” and “the” include plural references unless the context clearly dictates otherwise. Unless defined otherwise, all technical and scientific terms used herein have the same meanings as commonly understood by one of ordinary skill in the art. Nothing in this disclosure is to be construed as an admission that the embodiments described in this disclosure are not entitled to antedate such disclosure by virtue of prior invention. As used in this document, the term “comprising” means “including, but not limited to.”

The described technology generally relates to systems, methods, and computer program products for generating molds and/or related tooling (“a metal casting mold” or “tooling”) for creating metal products through a metal casting process. In some embodiments, the metal casting molds can be created using an additive manufacturing technique. In some embodiments, the metal casting mold can be used in an investment casting process using ferrous and/or non-ferrous metals. The methods and systems described herein can be used with various materials, including, without limitation, ferrous metals, non-ferrous metals, bronze, precious metals, aluminum, and/or combinations thereof, and/or the like. The methods and systems described herein can be used to create various products, including plaques, markers, memorials, signs, mechanical parts, and/or the like. A mold created according to some embodiments can be used in various casting processes, including, without limitation, sand casting, shell molding, permanent mold casting, investment casting, and die casting.

In some embodiments, a mold manufacturing system (“manufacturing system”) may receive a product design to be manipulated/modified using scanning technologies and/or manual data manipulation to prepare files for use with additive manufacturing and other three-dimensional printing systems. The digital input may be in the form of engineering files, such as point cloud files, polygon mesh files, spline surface files, Boolean solid geometry files, or other related computer-aided design (CAD) files, raster/vector type files, and/or the like. In some embodiments, the manufacturing system may use stereolithography (*.stl) files for use with additive manufacturing systems.

Some embodiments are directed to a method of generating a mold, the method comprising obtaining a product design through a digital input, manipulating the digital input to prepare a mold information, and making a mold from the mold information using an additive manufacturing process. In some embodiments, a method of making a cast product may comprise obtaining a product design through a digital input, manipulating the digital input to prepare the mold information, making a mold from the mold information using an additive manufacturing process, positioning the mold in a build area, forming a cast part or a cast product from the mold using a cast material; and, optionally, finishing the cast product per customer specifications. In some embodiments, one or more cast parts are needed for the cast product. In some embodiments, the digital input is manipulated/modified to optimize a mold design for the additive manufacturing process. In some embodiments, the digital input may be manipulated/modified to make a mold design by optimizing part size, dimensional depth, dimensional profile, profilometry (surface roughness/finish), strength, porosity, compaction, orientation, feature complexity, or the like. This manipulation and/or modification of the digital input can optimize the final product and/or processing characteristics across the scope of manufactured products. In some embodiments, the feature complexity may include typefaces or design aspects. In some embodiments, individual mold designs may be nested to optimize material use and production speed during the additive manufacturing process.

A variety of additive manufacturing technologies will be known to a person of skill in the art. Such technologies include, for example, binder jetting, directed energy deposition, material extrusion, material jetting, powder bed fusion, sheet lamination, and vat photopolymerization. These technologies may use a variety of materials for an additive manufacturing process, including various plastics and polymers, metals and metal alloys, ceramic materials, metal clays, organic materials, and the like. Any additive manufacturing technology and substrate suitable for the production of molds of embodiments herein and compatible with the molding of metal products, or compatible with the manufacturing of molds that may be subsequently used to mold metal products, is within the scope of the present disclosure. Likewise, other methods of additive manufacturing and associated materials, whether presently available or yet to be developed, are intended to be included within the scope of the present disclosure.

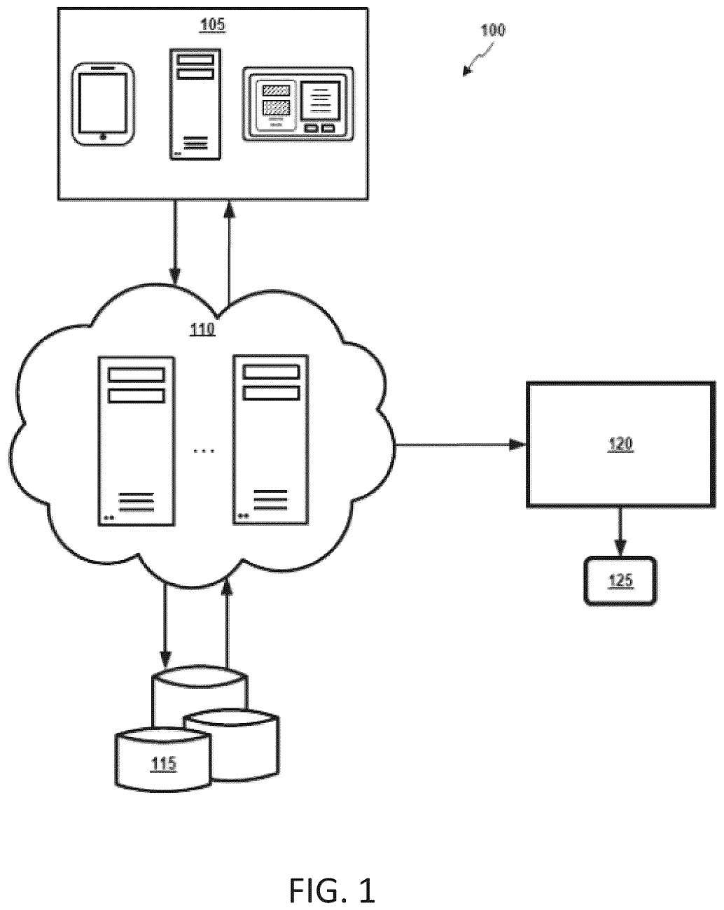

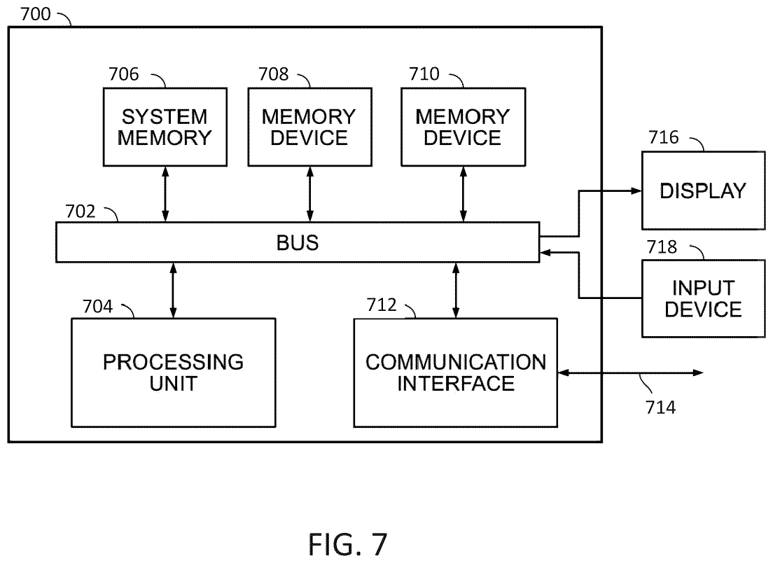

FIG. 1 depicts an illustrative manufacturing system according to an embodiment. As shown in FIG. 1, the manufacturing system 100 can include one or more system logic devices 110, which can generally include a processor, a non-transitory memory or other storage device for housing programming instructions, data or information regarding one or more applications, and other hardware, including, for example, the processing unit (CPU) 704, system memory 706, communication interface 712, and/or memory devices 708/710 depicted in FIG. 7 and described below in reference thereto. In some embodiments, the system logic devices 110 can include server computing devices, workstation computing devices (personal computers or “PCs”), and/or the like. In some embodiments, the system logic devices 110 can be a part of a control system for a mold manufacturing device 120, such as an additive manufacturing device or three-dimensional printing device.

In some embodiments, the programming instructions can include a mold manufacturing application (the “manufacturing application”) configured to, among other things, design and/or generate a mold. The system logic devices 110 can be in operable communication with client logic devices 105, including, but not limited to, server computing devices, personal computers (PCs), kiosk computing devices, mobile computing devices, laptop computers, smartphones, tablet computing devices, cloud computing devices, or any other logic and/or computing devices now known or developed in the future.

In some embodiments, the manufacturing application can be accessible through various platforms, such as a client application, a web-based application, over the Internet, an e-commerce portal, and/or a mobile application (for example, a “mobile app” or “app”). According to some embodiments, the manufacturing application can be configured to operate on each client logic device 105 and/or to operate on a system logic device 110 accessible to client logic devices over a network, such as the Internet. All or some of the files, data and/or processes (for example, source information, de-identification processes, data sets, or the like) used for accessing and/or de-identifying information can be stored locally on each client logic device 105 and/or stored in a central location and accessible over a network.

In an embodiment, one or more data stores 115 can be accessible by the client logic devices 105 and/or the system logic devices 110. In some examples, the data stores 115 can include information sources having information used to design and/or generate a mold or customized portions of molds. For example, data stores 115 can include, without limitation, information from product catalogs, historical mold information, mold pattern information (e.g., mold templates, dimensions, cost information, and/or the like), e-commerce information, production information (e.g., SKU number), material information, and/or the like. In some embodiments, the data stores 115 can include information obtained from multiple data sources, including third-party data sources.

Although the one or more data stores 115 are depicted as being separate from the logic devices 105, 110, embodiments are not so limited. All or some of the one or more data stores 115 can be stored in one or more of the logic devices 105, 110.

The system logic devices 110 can receive product specifications for a product. The product specifications can be analyzed by the manufacturing application to generate mold information. In some embodiments, the product specifications can be in the form of a digital file. The mold information can be transmitted to a manufacturing device 120, such as an additive manufacturing system. The manufacturing device 120 can generate a mold 125 based on the mold information. For example, the manufacturing application can generate, look up, or otherwise obtain information from the product specifications and translate this data into mold information that can be used by the manufacturing device 120 to generate the mold 125. In some embodiments, the mold information can be in the form of a digital file (e.g., an *.stl file). The mold 125 can be used in various metal casting processes to generate a product, including, without limitation, sand casting, shell molding, permanent mold casting, investment casting, and die casting.

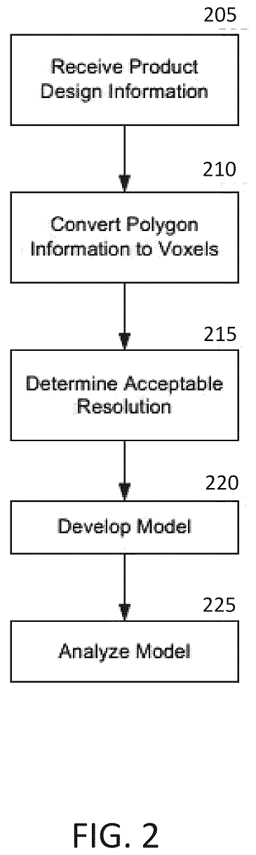

FIG. 2 illustrates a sample flow diagram for generating a product design. A system running a modeling application or similar software and implemented on a processing device such as logic devices 105, 110, can receive 205 product design information for a product to be modeled and cast. In certain implementations, the product design information may include a digital representation of the product, such as a three-dimensional image file. In some implementations, the product design information may include a series of characters (e.g., text) and characteristics of the characters (e.g., font and size). In some examples, the digital representation is loaded, created or otherwise obtained from, for example, a standard library of product files. For example, the product file may include product-specific information, such as shape, surface structure, material and associated material properties (e.g., reflectance, color, gloss, anisotrophy, scattering properties, and translucency), and other related information. In some implementations, a user may alter the standard library files to include additional detail, such as text, images, or other adornments or decorations. For example, when creating a plaque, the user may load a standard product file representing various dimensions of the plaque (i.e., length, width and depth), standard ornamentations or decorations (e.g., specific borders, raised or lowered features, and other similar decorations), and other standard features. Additionally, the user may use an interactive editing tool to add additional detail, such as text (e.g., a person's name, relevant dates, and other information related to the product being created), additional decorations (e.g., images), and any other elements that the design system is configured to support.

In order to accurately create a three-dimensional model of the product, the product design information may initially be modeled as polygonal information (e.g., a series of vector-based coordinates defining the extreme outer surfaces of the model). The polygonal information can then be converted 210 into voxel information. In computer design and modeling, voxels refer to volumetric elements, or elements that take up a definable space in a three-dimensional grid. Typically, a voxel is defined by its position relative to other voxels in a design. As a result, voxels are used to accurately represent spaces that are non-homogeneously filled more easily than polygonal information because polygons are typically only represented by a coordinate set, and not as they relate to other parts of a design. In certain implementations, converting 210 the polygonal information to voxel information may be performed on a pixel-by-pixel basis. In such an example, a pixel mask or other similar means for dividing the polygonal information may be applied to the product design information such that the product design is divided into an array of pixel-sized components. Each pixel-sized component may be converted to voxel information using standard information and/or data conversion techniques.

During conversion 210, certain aspects and information related to the product should be maintained at a high level of accuracy (e.g., within a specific sizing and spacing threshold to the original product). As such, the model should retain depth illusion, depth compression, shape compression, silhouette collapse, object order, and other similar aspects.

Depending upon the size of the voxels (which can be dependent on, for example, the size of the pixel information used during the conversion as described above), the accuracy of the design software, and the manufacturing capabilities of the manufacturing device creating the mold, an acceptable resolution may be determined 215. For example, specific layer thicknesses and surface roughness values may be determined for a specific model. In order to accurately determine 215 the resolution, additional information, such as the size of the particulate (e.g., sand) being used to create the mold, may be considered. Based upon the size of the particulate, a certain level of resolution may be difficult to achieve when creating the mold.

After the polygon information is converted 210 and the resolution is determined 215, the processing device may develop 220 the model as a 3D model file stored, for example, on a computer readable medium operably connected to the processing device. The model may be analyzed 225 by, for example, the designer of the model. In certain implementations, the processing device may be configured to automatically analyze 225 the model to determine whether the dimensions of the model, shapes, features, text, resolution, and other related parameters and properties were properly converted and modeled.

Depending upon the number of products being cast, the process as shown in FIG. 2 may be repeated a plurality of times to create a digital 3D model for each such product being cast.

The process as described in FIG. 2 may be used in various industries where products are cast using customized molds. However, the techniques as described herein are particularly applicable to industries where highly customizable one-off products are created. For example, memorialization services that create bronze or other similarly cast products for burial markers, urns, awards, plaques, nameplates, and other similarly customized products would benefit from the mold creation and casting techniques described herein.

The development of molds according to some embodiments provides multiple non-limiting technological advantages over conventional processes. One non-limiting technological advantage is that molds produced via additive manufacturing according to some embodiments may be made to specifications and parameters that optimize cycle time and product quality in a typical casting process, for instance, involving a casting flask and its corresponding cope and drag sections. Other non-limiting benefits may include that processes described in embodiments herein may use less material than conventional techniques, may be less labor-intensive, may result in less wasted material, and/or may expedite mold creation.

One non-limiting example of a technological advantage is dimensional stability, including the ability to generate and/or use remolds. Methods and systems according to some embodiments may provide product manufacturers with the non-limiting technological advantages of increased speed to market and/or decreased lead times, reduced or eliminated dimensional constraints, broader applicability across substrates, and the ability to recycle and/or reuse product specifications, mold information, or the actual molds themselves. The reclamation of mold materials may result in equally consistent mold quality and a cost savings. Reclamation of mold materials may include the separation of some or all of the constituents of the mold, such as foundry sand or related materials, binder materials, or activator materials, or other additives, that aid in the additive manufacturing process and/or the downstream processes. Successful reclamation efforts are identified as any level of reduction, reuse, or recyclability that provide an economic or other strategic advantage. In particular, the additive manufacturing process may allow for single and direct processing of molds with no post-print cure requirements.

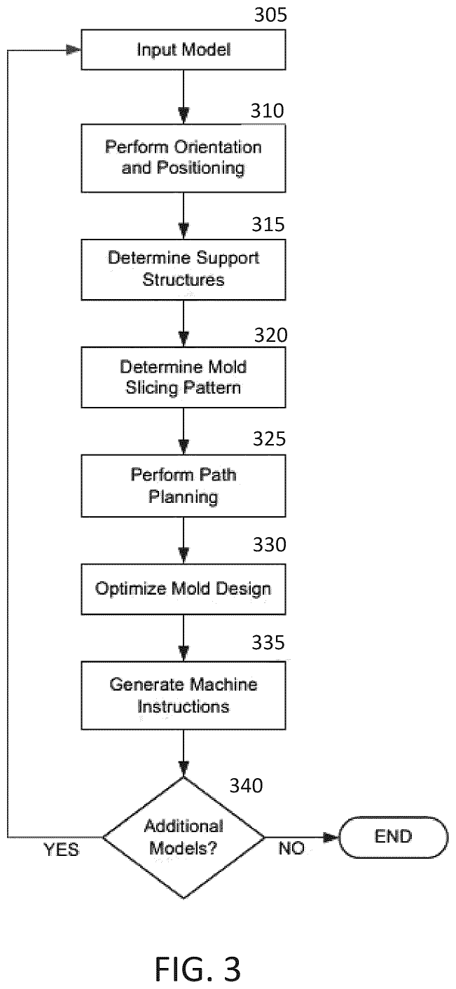

Once the product model has been created, a mold for casting the product can be designed. FIG. 3 illustrates a sample process for creating a mold for a specific digital product model. A processing device, such as logic devices 105, 110 as described above, or a processing device integrated into, for example, manufacturing device 120, may input 305 a product model. It should be noted that, when creating a mold for casting a product, the model of the product can be used as a template to create the mold. Thus, the mold is shaped as a negative of the model, defining open spaces associated with solid features of the products, and having solid spaces associated with open features of the product.

Referring again to FIG. 3, after the model is input 305 and loaded, the processing device can orient and position 310 the model such that a mold can be created representing the various features of the product being cast. In some implementations, depending upon the size and shape of the product to be cast, a plurality of molds or mold portions may be created and combined prior to casting. The processing device may determine 315 any support structures that might be required for providing structural integrity to the mold during the casting process. For example, internal support and shaping structures may be determined 315 for the mold being created.

The processing device may determine 320 a mold slicing pattern. The mold slicing pattern may be configured such that it reduces eliminated geometry and staircase effects from the additive manufacturing process. As noted above, the additive manufacturing process can use a particulate such as sand to create the mold. As such, the various features of the mold may not be perfectly smooth. Rather, they can only be as smooth as the size of the particulate being used. As such, by accurately determining 320 a mold slicing pattern, staircase effects may be reduced.

The processing device may perform 325 path planning for the mold creation process. In certain implementations, the path planning includes specific movements and instructions for causing the manufacturing device to produce the mold. Typically, manufacturing devices include optimization software for performing accurate path planning specific to the functions and capabilities of that specific manufacturing device.

The processing device may further optimize 330 the mold design. In certain implementations, optimizing 330 the mold design may include one or more of determining a wall thickness to prevent blow-out defects, determining a minimum mold height to achieve an independent and/or stable pour velocity (according to, for example, Chvorinov's Rule), determining a pour cup strategy, determining a venting strategy, and determining other optimization parameters, such as angling the mold, modifying the orientation of the mold, and other similar ideas and concepts.

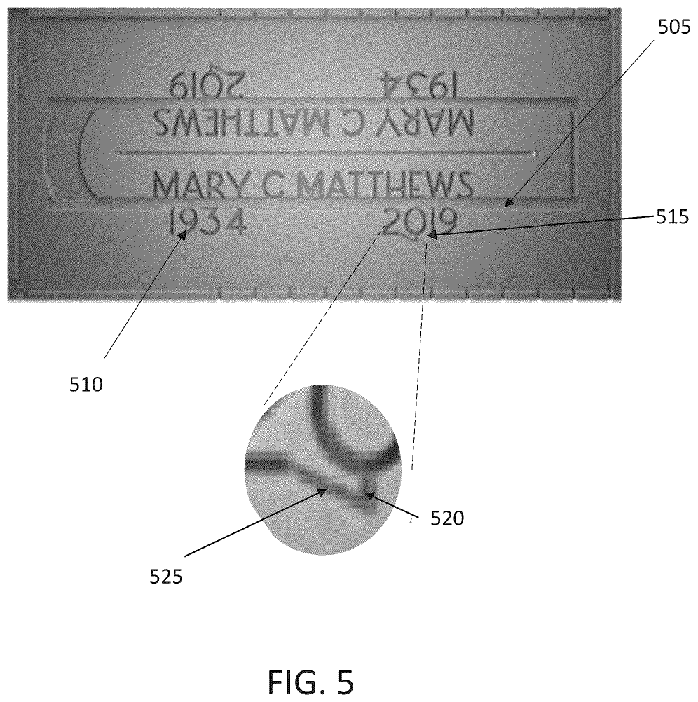

In certain implementations, optimizing 330 the mold design may include optimizing one or more characters present in the mold. The one or more characters may be configured without a backing substrate in the final product. This configuration often results in low yield rates resulting from poor flow through shallow depth and excessive bend radii in certain characters. To improve yield rates, the processing device may detect problematic characters with some combination of an insufficient depth and/or excessive bend radius. In some implementations, an insufficient depth may be determined by comparing a depth with a predetermined threshold. Any character bend that results in a directional change of flow, during a pour, in opposition to the primary direction of initial flow may be detected as problematic. The primary direction of initial flow may be perpendicular with respect to a bar or gate to which the characters are attached, as illustrated in FIG. 5. Common problematic characters for excessive bend radius may include C, S, Z, 2, and 5. The threshold for the maximum directional change of flow may be between 60 to 90 degrees from the primary direction of initial flow. In further implementations, the processing device may offer varying warnings over a range of detected insufficient depths and/or excessive bend radii. In some implementations, the processing device may determine an estimated chance of successful pour given one or more detected issues.

The processing device may determine a recommended optimization to remedy the problematic characters. For example, where a character is detected with insufficient depth, the processing device may recommend increasing the depth of the character. In another example, where a character is detected with an excessive bend radius, the processing device may recommend adding a gate between the problematic character and another character (e.g., the adjacent character). The recommended optimization may be visualized along with the detected problematic character or listed separately. In certain implementations, the processing device may automatically apply the recommended optimization to the model. Alternatively, an operator may be prompted to choose whether to apply the recommended optimization.

The processing device may generate 335 the actual machine instructions for creating the mold and store the machine instructions on a computer readable medium operably connected to the manufacturing device for execution by the manufacturing device when creating the mold. The processing device may further determine 340 whether molds can be created for additional modeled products. If additional models exist, the process as described in FIG. 3 can be repeated for each model. If no additional models exist, the process as shown in FIG. 3 can complete.

In an embodiment, after performing the process in FIG. 3, the actual mold may be created as described above in FIG. 2. For example, an additive manufacturing process may be used to create the mold from, for example, sand or another similar particulate. After mold creation, the mold may be cleaned, inspected, and, if the mold passes quality control, the product can be cast. As the molds are typically destroyed when removing the cast product, creating a custom mold for each custom product, such as a memorialization product like a bronze plaque, can be expensive and time consuming when done one at a time by hand. However, using the process as described herein, a person can design multiple products, create instructions for creating the molds, and create the molds in a single batch process, for example, overnight, thereby reducing the amount of time a single employee spends on each product while maximizing efficiency.

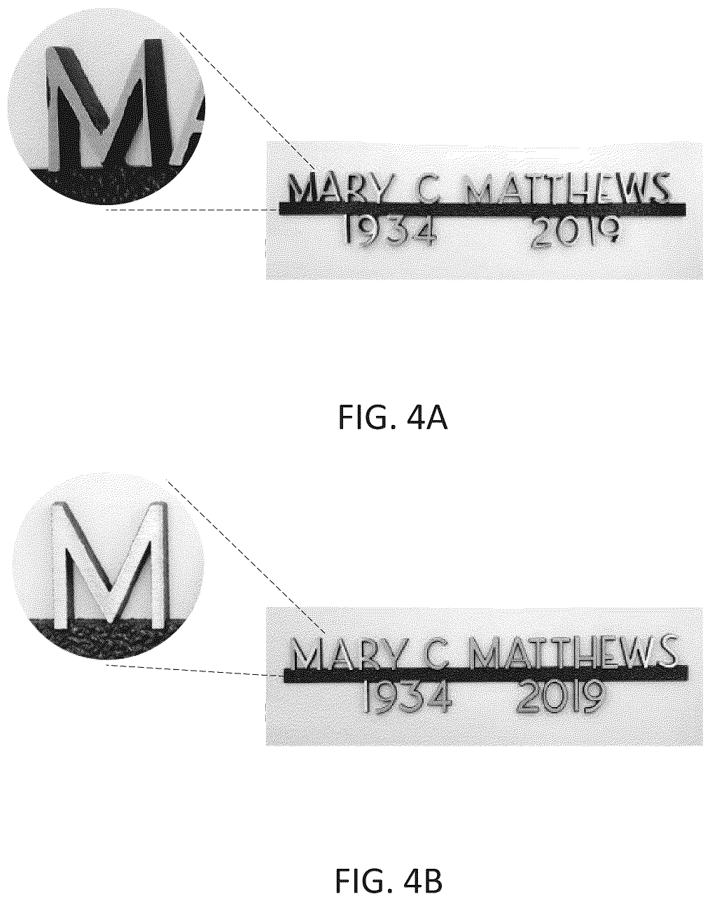

FIG. 4A depicts an example casting featuring a series of characters produced using traditional casting methods. Products of this type are traditionally typeset by hand (i.e., a person manually aligns letters in the mold). As a result, the characters may be out of alignment (e.g., shifted, rotated, incorrectly spaced, and/or out of plane with respect to the other characters or other features such as a bar). Character misalignment in the mold, in addition to limited character depth and excess bend radius, may impede flow during the casting process. In the example of FIG. 4A, the ‘9’ in ‘2019’ did not complete due to insufficient flow. The systems and methods described herein may aid in correcting issues with character alignment.

FIG. 4B depicts an example casting featuring a series of characters produced using the methods described herein. Computer controlled additive manufacturing for mold production may greatly outperform a human operator at character alignment.

FIG. 5 illustrates an example mold for a product comprising a bar 505 with a series of characters 510 attached to the bar 505. The bar 505 may be an intended feature of the final product. Alternatively, the bar 505 may function as a runner for casting the series of characters 510 simultaneously (i.e., the bar 505 may be removed after casting). Based on the optimization techniques described herein, the processing unit or an operator may add one or more gates 515 to problematic characters.

In certain implementations, gates 515 are configured to have a depth within a first range and/or a bend radius within a second range to allow for flow during a pour. In some implementations, gates 515 may have similar configuration. An advantageous gate 515 configuration is illustrated in FIG. 5. The advantageous gate 515 configuration includes a first portion 520, connected to one of the joined characters, perpendicular to the bar (i.e., the primary direction of initial flow), and a second portion 525 bridging between the end of the first portion 520 and the second of the joined characters. In some implementations, the gate 515 joins characters 510 near their distal ends from their connecting points to the bar 505.

In some implementations, gates 515 may be customized based on the typeset of the characters 510. For example, deeper characters 510 may accommodate deeper gates 515. Adding depth beyond what is necessary may add additional work in removing the gate on completing the casting.

In some implementations, gates 515 may be customized to the specific characters 510 being joined. Optimal gate 515 configurations may be known between specific characters 510. Alternatively, the processing device may optimize a gate 515. An optimized gate 515 may satisfy some combination of weighted parameters including depth, maximum bend radius at a given point, bend radius per unit length, total length, and/or distance of the gate's connection to the end of a joined character.

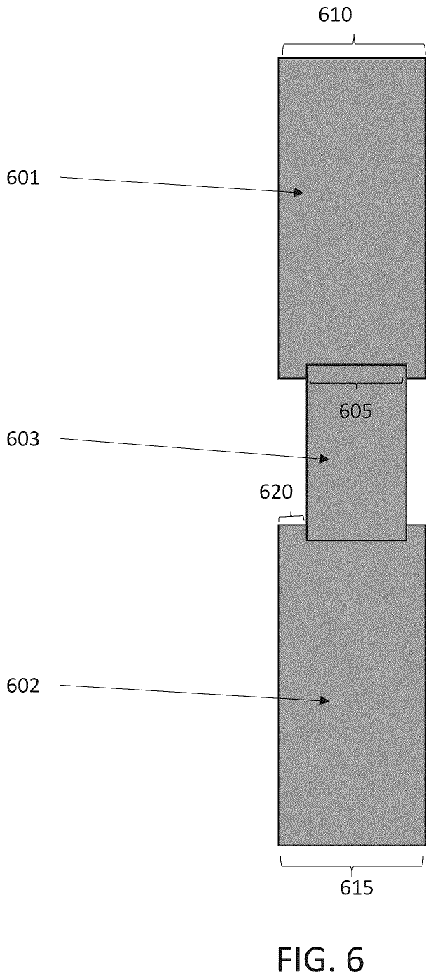

FIG. 6 illustrates a simplified side view of a casted product made in a mold similar in configuration to the mold depicted in FIG. 5. A first row of characters 601 with a given depth 610 may be connected to a bar 603. Similarly, a second row of characters 602 with a given depth 615 may be connect to the bar 603. The depths 610/615 of the first 601 and second 602 rows of character may or may not be the same. The bar 603 may have a depth 605 greater or less than the character rows 601/602. For example, the character rows 601/602 may protrude a distance 620 away from the bar 603. Based on the depth 610/615 of the character rows 601/602 in relation to the depth 605 of the bar 603, it may be advantageous to add depth to character row 601/602, when recommended as described the methods herein, in specific locations. For example, minor increases in depth on the back of the characters may not make a noticeable change in the overall appearance of the product, while removing issues with problematic characters.

FIG. 7 is a schematic block diagram illustrating an example system 700 of hardware components capable of implementing examples of the systems and methods disclosed herein. The system 700 can include various systems and subsystems. The system 700 can include one or more of a personal computer, a laptop computer, a mobile computing device, a workstation, a computer system, an appliance, an application-specific integrated circuit (ASIC), a server, a server BladeCenter, a server farm, etc.

The system 700 can include a system bus 702, a processing unit 704, a system memory 706, memory devices 708 and 710, a communication interface 712 (e.g., a network interface), a communication link 714, a display 716 (e.g., a video screen), and an input device 718 (e.g., a keyboard, touch screen, and/or a mouse). The system bus 702 can be in communication with the processing unit 704 and the system memory 706. The additional memory devices 708 and 710, such as a hard disk drive, server, standalone database, or other non-volatile memory, can also be in communication with the system bus 702. The system bus 702 interconnects the processing unit 704, the memory devices 808 and 710, the communication interface 712, the display 716, and the input device 718. In some examples, the system bus 702 also interconnects an additional port (not shown), such as a universal serial bus (USB) port.

The processing unit 704 can be a computing device and can include an application-specific integrated circuit (ASIC). The processing unit 704 executes a set of instructions to implement the operations of examples disclosed herein. The processing unit can include a processing core.

The additional memory devices 706, 708, and 710 can store data, programs, instructions, database queries in text or compiled form, and any other information that may be needed to operate a computer. The memories 706, 708 and 710 can be implemented as computer-readable media (integrated or removable), such as a memory card, disk drive, compact disk (CD), or server accessible over a network. In certain examples, the memories 706, 708 and 710 can comprise text, images, video, and/or audio, portions of which can be available in formats comprehensible to human beings.

Additionally, or alternatively, the system 700 can access an external data source or query source through the communication interface 712, which can communicate with the system bus 702 and the communication link 714.

In operation, the system 700 can be used to implement one or more parts of a system in accordance with the present invention, such as system 100. Computer executable logic for implementing the diagnostic system resides on one or more of the system memory 706, and the memory devices 708 and 710 in accordance with certain examples. The processing unit 704 executes one or more computer executable instructions originating from the system memory 706 and the memory devices 708 and 710. The term “computer readable medium” as used herein refers to a medium that participates in providing instructions to the processing unit 704 for execution. This medium may be distributed across multiple discrete assemblies all operatively connected to a common processor or set of related processors.

It will be appreciated that various of the above-disclosed and other features and functions, or alternatives thereof, may be desirably combined into many other different systems or applications. It will also be appreciated that various presently unforeseen or unanticipated alternatives, modifications, variations or improvements therein may be subsequently made by those skilled in the art which alternatives, variations and improvements are also intended to be encompassed by the embodiments described above.

What is claimed is:

1. A method for creating a mold for a memorialization product comprising characters without a backing substrate, the method comprising:
generating a three-dimensional (3D) model of a product design, wherein the product design includes characters with customized features;
generating a mold design based upon the 3D model of the product design;
optimizing the mold design, wherein optimizing the mold design comprises optimizing the characters based on a depth and bend radius of the characters;
generating printing instructions for creating the mold; and
creating a mold for casting the memorialization product according to the printing instructions.

2. The method of claim 1, wherein generating the 3D model comprises:
receiving product design information, wherein the product design information contains polygonal information;
converting the polygonal information to voxel information;
determining an acceptable resolution for the 3D model; and
generating the 3D model based on the voxel information at the acceptable resolution.

3. The method of claim 2, wherein the product design information comprises typeset information and wherein generating the 3D model further comprises:
aligning the characters; and
converting the typeset information to the voxel information.

4. The method of claim 1, wherein generating the mold design comprises:
orienting and positioning the 3D model;
determining one or more support structures for the mold design;
determining one or more slicing patterns for the mold design;
performing path planning for the mold design;
optimizing the mold design; and
generating the mold design.

5. The method of claim 1, wherein optimizing the mold design comprises at least one of:
determining a wall thickness;
determining a minimum mold height;
determining a pour cup strategy; and
determining a venting strategy.

6. The method of claim 1, wherein creating the mold comprises creating the mold using an additive manufacturing process.

7. The method of claim 1, wherein creating the mold comprises creating the mold by 3D sand printing.

8. The method of claim 1, further comprising casting the memorialization product by adding molten metal to the created mold.

9. The method of claim 1, wherein optimizing the characters comprises comparing a bend radius of a character to a threshold bend radius.

10. The method of claim 9, wherein the threshold bend radius is 60 degrees from a primary direction of initial flow for the mold.

11. The method of claim 9, further comprising:
in response to the bend radius of the character exceeding the threshold bend radius, augmenting the 3D model with a gate connecting the character and an adjacent character.

12. The method of claim 11, wherein the gate comprises a portion parallel to a primary direction of initial flow for the mold.

13. The method of claim 11, further comprising customizing the gate based on the customized features of the characters.

14. The method of claim 1, wherein optimizing the characters comprises analyzing the depth of a character in comparison to a threshold depth.

15. The method of claim 14, further comprising:
in response to the depth of the character being less than the threshold depth, adding depth to the character such that the depth of the character equals the threshold depth.

16. A system for creating a mold for a memorialization product comprising characters without a backing substrate, the system comprising:
a processor; and
a non-transitory, computer-readable storage medium in operable communication with the processor, wherein the computer-readable storage medium contains one or more programming instructions that, when executed, cause the processor to:
generate a three-dimensional (3D) model of a product design, wherein the product design includes characters with customized features;
generate a mold design based upon the 3D model of the product design;
optimize the mold design based on a depth and bend radius of the characters; and
generate printing instructions for creating the mold.

17. The system of claim 16, further comprising an additive manufacturing device configured to generate the mold based on the printing instructions.

18. The system of claim 16, wherein the one or more programming instructions that cause the processor to generate the 3D model further comprise one or more programming instructions that cause the processor to:
receive product design information, wherein the product design information contains polygonal information;
convert the polygonal information to voxel information;
determine an acceptable resolution for the 3D model; and
generate the 3D model based on the voxel information at the acceptable resolution.

19. The system of claim 18, wherein the product design information comprises typeset information and wherein the one or more programming instructions that cause the processor to generate the 3D model further comprise one or more programming instructions that cause the processor to:
align the characters; and
convert the typeset information to the voxel information.

20. The system of claim 16, wherein the one or more programming instructions that cause the processor to generate the mold design further comprise one or more programming instructions that cause the processor to:
orient and positioning the 3D model;
determine one or more support structures for the mold design;
determine one or more slicing patterns for the mold design;
perform path planning for the mold design;
optimize the mold design; and
generate the mold design.
